(19) United States
(12) Patent Application Publication
(10) Pub. No.: US 2012/0298153 A1
(43) Pub. Date: Nov. 29, 2012

(54) WASHING APPLIANCE WITH DEDICATED WATER-SOFTENER

(75) Inventors: Leonard Paul Seed, Guelph (CA); Iurie Pargaru, Guelph (CA); Gene Sidney Shelp, Guelph (CA)

(73) Assignee: ENPAR Technologies Inc., Guelph, ON (CA)

(21) Appl. No.: 13/522,562

(22) PCT Filed: Feb. 7, 2011
(86) PCT No.: PCT/CA2011/000133

§ 371 Date: Jul. 17, 2012

(30) Foreign Application Priority Data
Feb. 8, 2010 (GB) 1002006.3

(51) Int. Cl. B08B 3/00

(52) U.S. Cl. 134/109

(57) ABSTRACT

The softener is based on a capacitive-deionization (CDI) cell, in which the hardness ions are extracted, and disposed of still intact, in concentrated form. The softener is combined with a chelate to inhibit precipitation, in the appliance, from the concentrated effluent. The chelate being citric acid, the acidity is effective to keep the hardness ions in solution. The purify and regenerate modes of operation of the softener can be timed to coincide with the washing and rinsing cycles of the appliance, whereby the presence of the softener does not affect the speed and performance of the appliance.

This technology relates to water-softeners, and in particular to water-softeners of the kind that can be used directly in conjunction with water-consuming appliances, such as washing-machines, dishwashers, and the like.

Traditionally, domestic water-softeners have been provided on a whole-house basis, rather than on an individual-appliance basis. Among the patent publications that do show water-consuming appliances with their own dedicated water softener, are WO-2006/079,417 (Unilever, 3 Aug. 2006), which shows the use of a capacitive-deionization (CDI) water-softener in an appliance, and EP-1,995,219 (Samsung, 26 Nov. 2008), which shows the use of an ion-exchange water-softener in an appliance.

Hardness in water has a number of deleterious effects, for example: (a) the deposition of scale in water heaters and other vessels, and in plumbing; (b) the diminishment of the surfactant properties of soaps and detergents; and, indirectly, (c) the contamination of the environment with salt from traditional ion-exchange water softeners.

In this latter regard, the hardness-causing minerals and salts, themselves, are not generally regarded as contaminants, or as only minor contaminants, even in concentrated form, given that they are present in the water naturally. Thus, the use of CDI may be preferred over ion-exchange because, in CDI, the hardness-causing minerals and salts remain intact, whereby they can be discharged, in their original form, back into the environment.

It is preferred that the water softener used in the present technology be based on a CDI cell—or, more generally, that it be based on a softener in which the dissolved mineral salts that cause the hardness are transferred, still intact (but usually more concentrated), to drain. The use of the present technology with a water softener of e.g the ion-exchange type, where the hardness ions are exchanged with sodium ions, and are disposed of in the form of chloride salts, is less preferred.

For present purpose, chelate-water is water containing a substantial concentration of a chelant (chelator). A chelant is a chemical that has an affinity for metal ions such as Ca++ and Mg++, which are the cause of hardness in water. The chelate combination renders those ions inert, or at least substantially inhibits the reaction of those ions with other elements or ions, and in particular inhibits their ability to form salts that precipitate out of the water.

Traditionally, chelants are used in the presence of hard water, in many applications, in order to inhibit precipitation and scaling. A feature of the present technology lies in making it possible and convenient to incorporate a chelant into the operational cycle of a water-softener, especially a CDI cell, in certain applications that already utilize an operating cycle, such as domestic washing appliances (which includes laundry- and dish-washing machines).

A common chelant is citric acid. Citric acid is commonly included in soaps and detergents, to perform the function of inhibiting precipitation, and scale removal generally. Ca and Mg salts are more soluble at a low pH, and an acidic solution inhibits the formation of Ca and Mg precipitates. The use a chelant that is also acidic thus serves to keep the salts in solution, and serves also to inhibit precipitations that might otherwise occur.

Again, it is recognized that the operational cycle of a CDI-based water-softener, and a precipitation-inhibitor based on the use of an acidic chelant such as citric acid, together can be advantageously incorporated into the operational cycle of a typical water-using appliance.

In a washing appliance, there are two main times when the appliance takes in water. First, the appliance takes in water for the washing cycle. Here, the water usually is hot and/or is heated. Second, several minutes later, the appliance disposes of the wash water, and takes in clean water for rinsing. As explained below, these cyclic operations can be arranged to interact advantageously with the parameters of the CDI cycle, together with the use of a chelate, and low pH, to inhibit precipitation.

### DETAILED DESCRIPTION OF PREFERRED EMBODIMENTS

The technology will now be further described with reference to the accompanying drawings, in which:

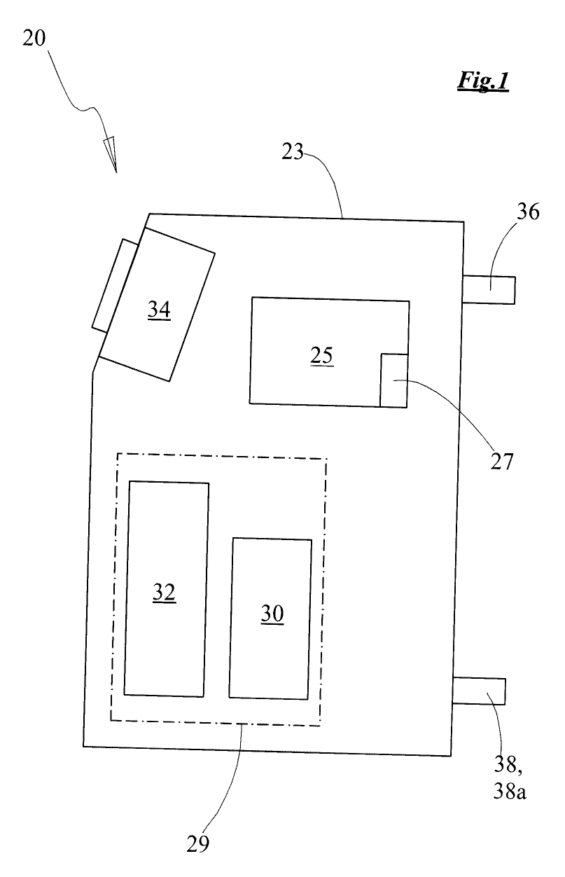

FIG. 1 is diagram of a washing appliance, showing some of the components thereof.

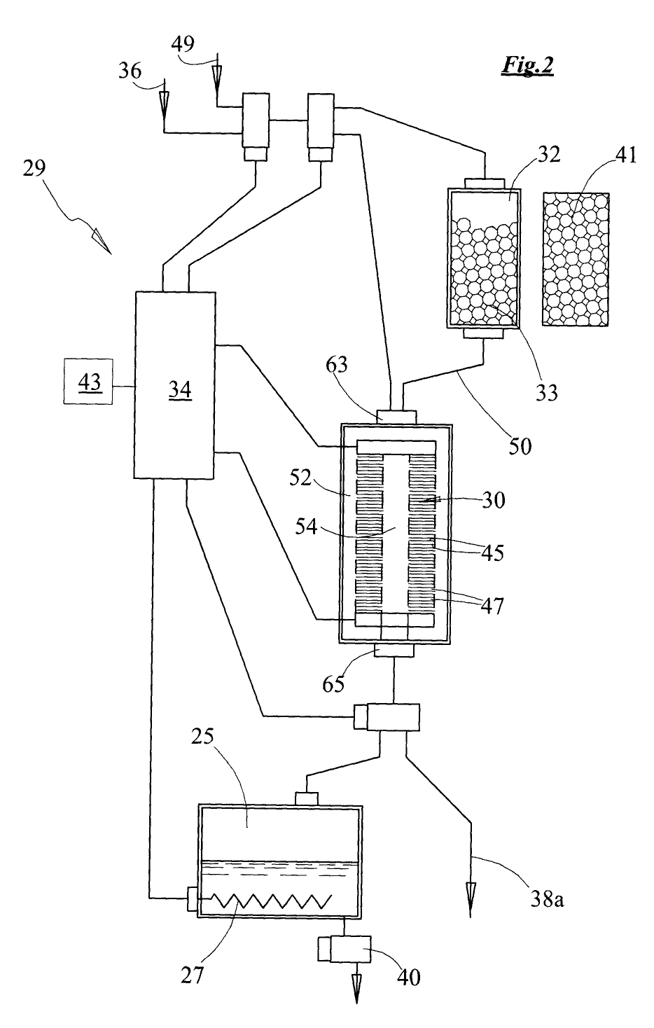

FIG. 2 is a diagram showing the functional arrangement of the water-softener system and of some of the associated components of the appliance.

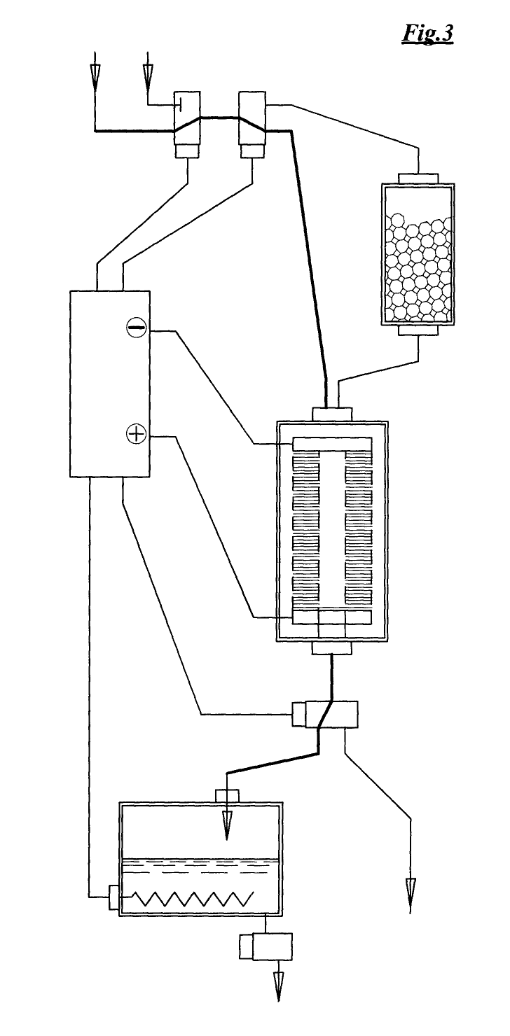

FIG. 3 is the same diagram as FIG. 2, but shows the system arranged to purify, i.e to soften, the water being used in the appliance.

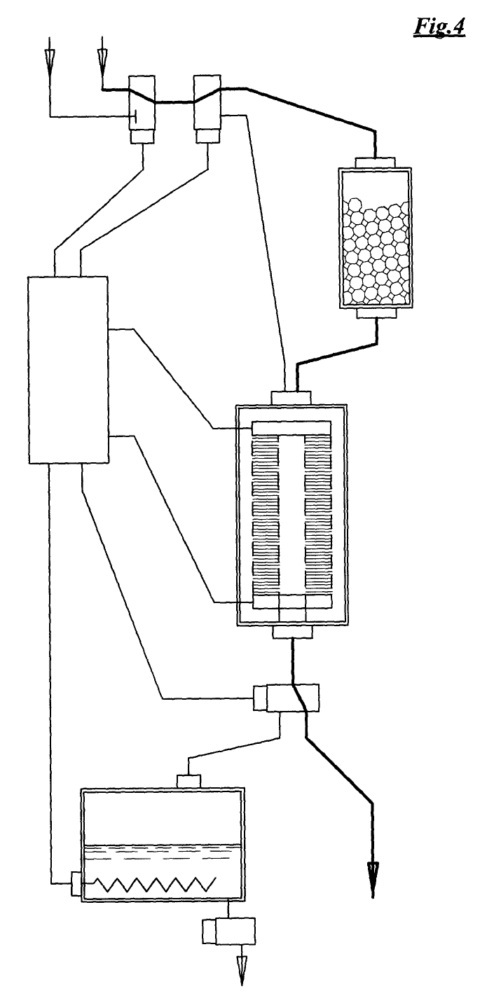

FIG. 4 is the same diagram as FIG. 2, but shows the system arranged for the displacement-phase of regeneration.

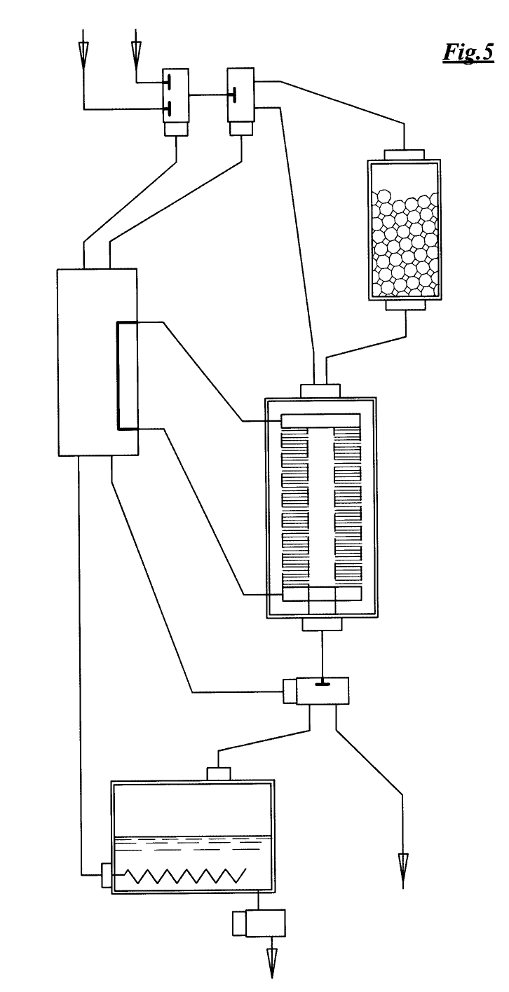

FIG. 5 is the same diagram as FIG. 2, but shows the system arranged for the release-phase of regeneration.

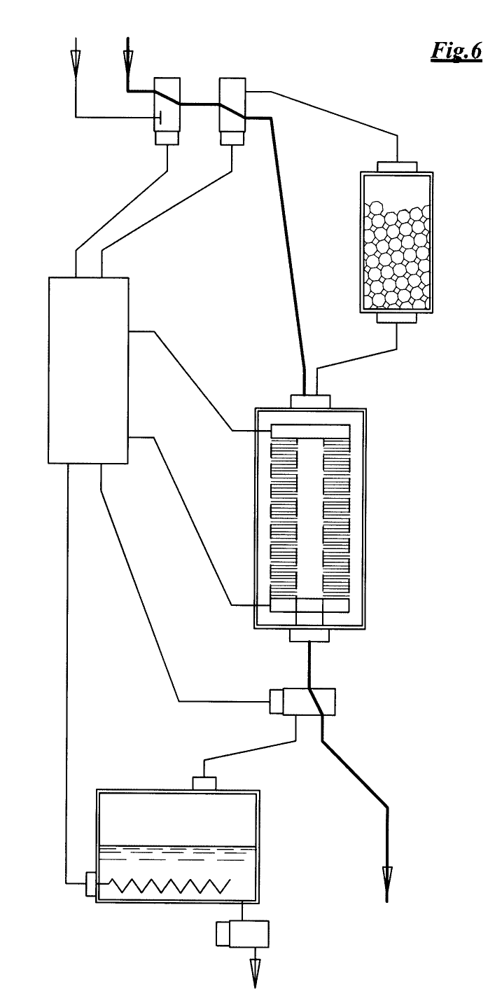

FIG. 6 is the same diagram as FIG. 2, but shows the system arranged for the purge-phase of regeneration.

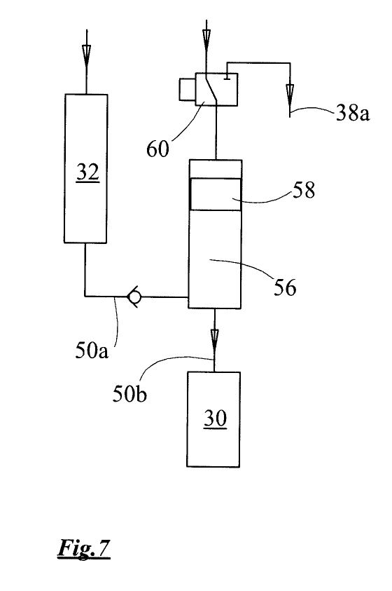

FIG. 7 is a diagram showing the inclusion of a storage-tank in the system of FIG. 2.

FIG. 1 is a diagram of a domestic washing appliance 20. Housed within the box 23 are a water reservoir 25, which is equipped with a heater 27, and a water softener 29. The softener 29 is based on a capacitive deionization (CDI) cell 30 and a cartridge 32 of citric acid pellets 33. The appliance includes a controller 34, which is associated with the usual manual buttons, appliance status indicators, etc.

A water inlet-port 36 admits water into the appliance from the water mains. Generally, since an on-board water-softener is provided as a component of the appliance, the water entering through the inlet 36 will be hard water, i.e will contain a high proportion of dissolved mineral salts. Hard water is water that contains e.g 200 mg/litre or more of hardness (as calcium carbonate or equivalent).

Sometimes, it might be the case that the incoming water has only a low or medium hardness, or has been somewhat pre-softened, being at e.g 100 mg/litre, and the on-board softener is being used to complete the job. There would be little point in the user purchasing an appliance having an on-board softener, if the hardness of the available mains-water were already very low, e.g 50 mg/litre or lower.

A water-outlet 38 conducts used water away from the appliance. Used water includes the water that has been used during the washing and rinsing functions of the appliance.

FIG. 2 is a diagram of the water softener 29 which indicates the relationship and connections between the components. The CDI cell 30 includes several pairs of electrodes. These may be arranged in suitable manner: in the example, the cell 30 is arranged as disclosed in patent publication WO-2010/069,065, but the present technology does not depend on the water-softener being based on this or that particular arrangement of CDI cell.

In some kinds of CDI cell that can be used in the present technology, charge-barriers are provided, which are effective, during regeneration of the cell, to prevent anions released from what was the anode during purification of the water, from becoming attached to the opposite electrodes, which have now become anodes during regeneration. Such charge-barriers may be active, being themselves electrically charged during operation; or may be passive, being e.g formed from permselective materials.

FIG. 3 is like FIG. 2, but shows the components arranged for operation in the purify-mode of the softener 29. Here, the controller 34 has set the various valves so that the incoming hard water, from the inlet-port 36, is routed into the CDI cell 30. Treated (i.e softened) water passes then to the water reservoir 25 of the appliance. From there, the water, usually having been heated, passes into the other components of the appliance, via a transfer valve 40, to take part in the washing operations.

In the CDI cell 30 are many pairs of electrodes 45. A power unit 43 feeds the controller 34, which controls the water-flow aspects of the appliance. The controller 34 also controls the supply of electrical energy for charging the electrode-pairs at the required polarity to the required voltage.

The electrodes comprise respective thin films or sheets of a high-surface-area electrically-conductive material, such as activated carbon. The surface-area of a gram of activated carbon can be several hundred square metres. The sheets used for CDI electrodes are typically two hundred microns in thickness.

The electrodes 45 are so arranged as to define capacitive-portions of the electrodes. An adjacent pair of the electrodes lie in such close-spaced face-to-face overlapping relationship as to create, when charged, a substantial capacitive effect between the pair.

The capacitive-portions of the electrodes that lie in that relationship define a thickness and a perimeter of a capacitance-space 47 that is located between the electrodes. The capacitance-space is defined as to its thickness by the face-to-face separation distance between the electrodes; and as to its perimeter in that, outside the perimeter of the capacitance-space, the electrodes are either curtailed, or the face-to-face separation distance between the electrodes is too large for substantive capacitive deionization to take place.

In the example, there are fifty electrodes, which are so wired as to be intercalated anode-cathode-anode-cathode etc. All the electrodes that were anodes in purify-mode become cathodes when the cell is switched to regenerate-mode.

The forty-nine spaces between adjacent pairs of electrodes are the forty-nine capacitance-spaces of the cell.

In the example, the adjacent pairs of electrodes are separated by dielectric spacers, having each a thickness of 100 microns. The thickness of the spacers defines the separation-distance between the electrodes. In many designs of CDI cell, charge barriers prevent the water itself from touching (wetting) the electrodes. In that case, the water is confined to occupying only the actual spaces between the electrodes. However, in other CDI designs, the electrodes are porous and permeable, and the water actually penetrates, and in some cases flows through, the material of the electrodes. In those cases, the capacitance-space is not just the volume of the space between the electrodes, but the designers note that the capacitance-space now should include an extra volume to allow for the volume of water that is actually inside the electrodes.

In the example, the capacitance-space 47 between a pair of the electrodes is configured as an annulus, of diameters 30 cm and 5 cm (being an area of 687 sq.cm.) The volume of one capacitance-space is this area multiplied by the separation distance between the electrodes (100 microns in the example), which is 17 cu.cm. The aggregate volume Vspaces of all forty-nine capacitance-spaces of the cell therefore is 842 cu.cm, or 0.842 litres.

The cell 30 should be so sized that it still has some margin of ability to absorb more hardness ions out of solution, even when the reservoir is filled. If the cell were to be filled with hardness ions before the reservoir was filled, of course, the water in the reservoir would not then be properly softened.

The softener remains in the purify-mode of the softener cycle while the reservoir is filling with incoming mains water. Filling the reservoir (and bringing the water up to temperature) can take e.g ten minutes. During this time, the water in the reservoir can be recirculated through the cell, the intent being to procure a more complete softening of the water. However, recirculation is not preferred, the preference being to completely soften the water in one single pass through the cell.

FIG. 4 shows the softener 29 in regenerate-mode, and shows the components arranged for a first phase of regeneration, being a displacement-phase of the regenerate-mode. Here, regen-water enters through the regen-inlet 49, and passes into the cartridge 32. The water already present inside the cartridge is therefore driven out, along conduit pipe 50, and into the cell 30.

The water that is driven out of the cartridge 32, and into the CDI cell 30, is water that has been residing in the cartridge, in contact with the citric acid pellets 33, for a residence period of at least a few minutes. This water is herein termed citric-water, and it can be expected that, given an adequate residence period, this citric-water is saturated, or almost saturated, with citric-acid.

In turn, the citric-water from the cartridge 32 drives out the water currently residing in the cell 30. That water is discharged through the regen-drain 38a, as shown in FIG. 4. The designers should arrange the softener such that the displacement-phase takes e.g between five seconds and thirty seconds.

Once all the capacitance-spaces 47 are filled with citric-water from the cartridge, now the controller 34 switches the softener 29 over to the second or release-phase of the regenerate-mode of the operational cycle. Here, as shown in FIG. 5, the valves are closed, such that there is no movement of water through the cell 30, nor through the cartridge 32, during the release-phase.

In the release-phase shown in FIG. 5, the controller 34 configures the electrical arrangement of the cell such that the hardness ions that have been sorbed out of the water and attracted to the electrodes 45 are now released or repelled from the electrodes, and into the water filling the capacitance-spaces 47, i.e into the citric-water. This release-phase is maintained until the capacitor is (practically) discharged, and until as many ions as can (practically) be removed from the electrodes have been transferred into the citric-water. The designers should arrange the softener so that the release-phase takes e.g between one minute and five minutes.

In the example, during the release-phase, the electrodes 45 are shorted together electrically, as shown in FIG. 5, whereby the ions are released from the electrodes. (In other designs of CDI cell, during the release phase, the electrodes 45 are supplied with voltage at opposite polarities from those applied during the purify-mode, whereby the ions that were retained in the electrodes during the purify-mode are now repelled from the electrodes.)

Once all the hardness ions have been released into the citric-water, now the controller 34 switches the softener 29 to the third phase of the regenerate-mode, namely the purge-phase, in which the softener is configured as in FIG. 6.

In FIG. 6, the controller 34 sets the valves and conduits to route mains-water through the cell 30. The citric-water that was in the cell, now laden with the released hardness ions, at a high concentration, e.g at 2,000 mg/litre, is disposed-of through the regen-drain 38a, leaving the cell filled with mains-water. As mentioned, the hardness minerals, even though now concentrated, cannot be regarded as a contaminant since they were present naturally in the water, and they quickly dilute down to natural levels. The citric acid quickly dilutes and dissipates. The designers should arrange the softener so that the purge-phase takes between five and thirty seconds.

The designers should arrange the softener so that the period of the regen-mode, overall, is about half the period of the purify-mode.

As shown in the drawings, the regen-water is admitted through a different inlet port 49 from the port 36 through which the mains-water is admitted. However, both may be admitted through the same port; indeed, if the designers so wish, the regen-water can be the same hard mains-water.

The water volume capacity of the cartridge, Vcartridge litres, should be enough to supply sufficient chelate-water to fill the cell, i.e should be as much as Vcell litres. Prudently, Vcartridge should have a marginal excess over Vcell. (The designers should ensure that so much citric-water cannot be moved out of the cartridge that there is no citric-water left, because then any further water moved out of the cartridge would simply be plain mains-water. Mains-water passing through the citric pellets with even a small velocity would be unlikely to become saturated with citric acid.) Given that a greater volume of citric-water might be needed, rapidly, in some circumstances, an option can be to provide a separate storage-tank, rather than provide a larger-capacity cartridge. Water in a larger cartridge becomes diluted whenever water is admitted into the cartridge, which adds to the time to reach saturation.

FIG. 7 shows the inclusion of a storage-tank 56 for regen-water, which may be inserted into the conduit 50, dividing the conduit into parts 50a,50b. The storage-tank 56 is provided with a sealed divider piston 58, which is movable up/down inside the tank.

In some circumstances, at the time when some chelate-water is needed for regeneration, it might happen that the regen-water currently residing in the cartridge 32 has not (yet) reached the desired degree of saturation with chelate. (This might happen, for instance, when the appliance is being called upon to provided multiple rinses in quick succession.) In that circumstance, to avoid waiting for the regen-water in the cartridge to become sufficiently saturated with chelate, a supply of already-saturated chelate-water is maintained, ready and waiting, in the storage-tank 56.

Normally, the storage-tank 56 not being needed, the piston 58 remains in its up-position. But if regeneration becomes imminent when the pH of the regen-water in the cartridge 32 is not (yet) low enough, the controller starts the displacement phase of regeneration by opening the valve 60. Mains-water now enters the space above the piston 58, and drives the piston downwards, in turn driving the saturated citric-water residing below the piston into the cell 30. The valve 60 then closes, and the remaining phases of regeneration take place in the cell 30 in the manner as described.

Later, when the regen-water in the cartridge 32 eventually does reach saturation, or reaches the desired concentration, the resulting chelate-water can be driven out of the cartridge (by admitting mains water into the cartridge, as described), whereupon the chelate-water enters the space below the piston 60, driving the piston 58 back to its up-position; the mains-water remaining above the piston 58 is ejected to drain 38a.

In the broad scope of the innovation described herein, the softener includes a hardness-ions extraction-structure, and a hardness-ions retention-structure. In the examples shown in the drawings, these two structures are combined, and embodied in the pairs of capacitor electrodes of the CDI cell. Alternatively, they can be embodied as separate structures.

The citric-acid, being a chelant, as well as having a low pH, inhibits the dissolved hardness ions from precipitating out of solution, even at the high concentrations, and thereby alleviates what might otherwise be severe scaling difficulties in the cell—and also in the pipes and conduits that conduct regen-effluent out of the appliance.

The electrodes 45 in the cell 30 having been stripped of sorbed hardness ions, and the cartridge 32 having been filled with mains-water, during the purge-phase, regeneration is now complete, and the softener 29 is ready to be switched back to the purify-mode. That is to say, the softener is ready for the cell to be charged, and to take hardness out of the next volume of mains-water passing through the cell. Of course, if that is the end of a washing episode, it may be e.g some days before the appliance is called upon again for the next washing episode.

Naturally, the designers are concerned not to waste the citric-water, i.e are concerned to minimize the volume of citric-water Vcitric that is needed to ensure that all the capacitance spaces of the cell are filled with citric-water, prior to the release-phase of regeneration. This, and other factors relating to the amount of regen-water Vregen that needs to be admitted during the displacement-phase of regenerate-mode, will now be considered, as follows.

Prudently, at the end of the purify-mode, the cell still has some marginal capacity to extract further hardness ions from the water, but notionally, at the end of the purify-mode of the operation, the capacitor electrodes of the CDI cell 30 are now (practically) fully-charged and the electrodes have now absorbed (practically) as many ions as they are capable of absorbing. The CDI cell needs to be regenerated before any more hardness ions can be extracted from water passing through the cell.

At this time, the capacitance-spaces 47 of the cell 30 are filled with softened water. In the example, before the release-phase of the regeneration operation commences, the function of the displacement-phase is to cause the volume Vspaces of water in the forty-nine capacitance-spaces of the cell to be replaced with chelate-water (in this case citric-water) from the cartridge 32. That is to say, the first operation, during regeneration, is to displace the water that currently occupies the capacitive-spaces in the cell, and replace it with chelate-water.

During the displacement-phase (FIG. 4), the controller 34 sets the conduits and valves to conduct incoming mains-water into and through the cartridge 32. The apparatus is designed to ensure that the incoming regen-water displaces the citric-water that is currently present in the cartridge. Thus, the incoming regen-water drives the citric-water out of the cartridge, and into the cell.

In turn, the incoming citric-water drives out the water currently present in the cell 30, and replaces it, in the cell, with citric-water. Thus, as this first phase (the displacement-phase) of regeneration come to an end, the water in the cartridge 32 now is regen-water that has not yet started, or has just started, to take-in citric-acid from the pellets; also, upon completion of the displacement-phase, the water in the cell now is citric-water—citric-water being water that is substantially saturated with citric acid.

The volume of regen-water Vregen that is admitted, during the displacement-phase, into the cartridge 32, should be large enough to drive sufficient citric-water out of the cartridge and into the cell 30, to occupy all the capacitance-spaces of the cell. At the same time, Vregen should not be so large as to move so much citric-water, during the displacement-phase, that some of the citric-water goes right through the cell, and to drain.

Again: Vregen, being the volume of regen-water admitted into the cartridge 32 (which is equal to the volume Vcitric of citric-water admitted to the cell), ideally should be just enough to ensure that all the capacitance-spaces 47 of the cell 30 are filled with saturated, or almost-saturated, low-pH citric-water. The pH of the citric-water in the cell, at just prior to commencement of the release-phase of regeneration, preferably should be under 4 pH, and more preferably under 2 pH.

The designers might arrange for the volume Vcitric of citric-water forced into the cell to be equal to Vspaces, being the aggregate volume of all the capacitance-spaces of the cell. In the example, as mentioned, Vspaces is 0.8 litres. However, generally, admitting only just the capacitance-volume Vspaces of the cell would not be enough to fill the capacitance-spaces, because, of course, some of the entering citric-water will reside in the plenums and conduits of and associated with the cell, rather than in the capacitance-spaces.

The volume Vcitric of citric-water that needs to be admitted into the cell, in order to ensure that (all) the capacitance-spaces of the cell are filled with low-pH citric water, is inevitably greater than just the sum Vspaces of the volumes of the individual capacitance-spaces. The cell 30 in the example includes an entry-plenum 52 and an exit-plenum 53, and at least the entry plenum 52 should contain, if not be filled with, citric-water, in order to ensure that all the capacitance-spaces are filled with citric-water at a low pH.

Vcell is the overall water volume capacity of the cell. The designers should aim to make the volume Vcell litres of water needed to actually fill the cell, only a little larger than Vspaces. Thus, the designers should seek to minimize or eliminate “dead” space (i.e anything outside Vspaces) from the water-containing areas of the cell, between the inlet 63 and outlet 65 ports of the cell. In the example, where the aggregate volume of all the capacitance spaces is a little under one litre, the designers should seek to ensure that the volume Vcell is under two litres. As a generality, Vcell should be no more than three times Vspaces. The cell 30 should be designed to cater for a flowrate of between 0.5 and 2 litres/minute.

The volume of citric-water Vcitric to be driven from the cartridge, and into the cell, during the displacement-phase, should be greater than Vspaces, and preferably should be nearer to Vcell, in order to ensure that, upon completion of the displacement-phase, all the capacitance-spaces are filled with low-pH citric-water.

The volume of citric-water Vcitric driven out of the cartridge and into the cell, during the displacement-phase, is (exactly) equal to the volume Vregen of regen-water that is admitted into the cartridge. Thus, the volume Vregen of regen-water that is admitted into the cartridge should be greater than Vspaces, and preferably should be nearer to Vcell, being the water capacity of the cell.

The designers should see to it that citric-water is not wasted, not only because the pellets cost money, but to maximize the interval before the cartridge needs to be replenished with pellets, as a service activity. Preferably, tests should be carried out, in which various quantities of regen-water are admitted into the cartridge, and the resulting pH of the water in the capacitance-spaces is measured. Then, the controller 34 can be adjusted to admit enough regen-water Vregen to procure the desired low value of pH of the water in the capacitance-spaces, but no more.

Some dilution of the citric-water on the journey between cartridge and cell is inevitable. The designer seeks to minimize this dilution, i.e seeks to maximize the degree to which the citric-water actually does displace the softened water that remains in the cell at the end of the purify-mode of the water treatment cycle.

Vcitric is the volume of saturated citric-water that needs to be transported into the cell, in order to ensure that all the capacitance-spaces 47 of the cell are filled with citric-water at pH of less than 4 pH. The actual volume Vcitric needed to do this depends, not only on Vcell itself, but on the particular design of cell used in the softener. A good rule, though, is that the volume Vcitric of saturated citric-water that is transported into the cell preferably should be about equal to the overall volumetric capacity Vcell of the cell. The designers should ensure that, in the displacement phase, the volume Vcitric, being the volume of citric-water that needs to be transported into the cell in order to ensure that all the capacitance-spaces of the cell are filled with citric-water at low-pH, exceeds Vspaces, but preferably should see to it that Vcitric exceeds Vspaces by as small a margin as is practicable.

As mentioned, during the release-phase of regeneration, during which the hardness-ions are released from the electrodes into the citric-water, in the example the citric-water in the cell is stationary. In an alternative, the designers may arrange for the citric-water in the cell to be stirred, and stirring can reduce the residence time needed to release (almost) all the hardness-ions, and to (almost) discharge the capacitor. However, the designers then should ensure that all the water being stirred is at the required low pH; if any water were to be stirred in were at a higher pH, of course stirring would cause a dilution of the citric water. Preferably, therefore, when stirring, the designers would provide shut-off valves at the inlet 63 and outlet 65 ports of the cell 30. Thus, stirring, if provided, likely would entail the expense, not only of the stirring means, but also of the provision of extra shut-off valves and a control system to operate the valves, which might not be economical in a domestic appliance.

As described, the various movements of water through the softener that are required in order to accomplish the purify-mode and the regeneration-mode of operations do not require the use of a pump. Rather, the pressure of the water mains powers the movements. On the other hand, small pumps of the kind already common in washing appliances can be provided economically, and it is not ruled out, in the present technology, that a powered pump could be used in the softener to move the waters about. Advantageously, however, in the present technology, designers of the softener system are free to omit a pump, if they wish.

The softener as described herein is accommodated within the housing or box of the appliance 20. Generally, there is space enough inside the appliance box 23 to accommodate the components of the softener 29. There is also room, in most cases, to accommodate a spare cartridge 41, which is then readily available to be slipped into place (e.g manually) when the quantity of citric acid in the current cartridge 32 starts to fall below a predetermined working level.

When the softener 29 is provided as original equipment on an appliance, the designers will have little trouble incorporating the controller 34 and its relatively simple functions into the already-provided sophisticated and complex control-unit that controls the water-use-cycles of the appliance.

Water-use-cycles of appliances may be regarded as including washing and rinsing. When not in use, of course the appliance stands idle, and during the idle time there is no problem providing the residence-time needed by the regen-water in the cartridge to become saturated with citric acid.

Upon using the appliance for a washing episode, the first intake of water is to fill up the reservoir 25 with softened water. The water volume capacity of the reservoir 25 being Vreservoir litres, the cell 30 should be sized so that Vreservoir litres of water, upon passing through the cell, can be softened, before the electrodes 45 in the cell become saturated with extracted hardness ions.

Once the reservoir is full, washing commences. At this point, the cell needs to be regenerated. Washing takes place over a period of, typically, ten to thirty minutes, during which time there is no further intake of water. The regeneration operations, as described, can easily be completed in this period. Therefore, when it is time for rinsing operations to commence, the cell has been well regenerated, and is able to soften the incoming rinse-water.

The appliance might provide, say, three or four rinses. Each rinse, the volume of water used is more or less equal to Vreservoir, or a little less. The time period between rinses is shorter than the time period between the wash operation and the first rinse, but still the time between rinses is likely to be at least two or three minutes. That is enough time for a CDI cell to be regenerated, so that the cell is ready to soften the next intake of water, for the next rinse. Of course, the designers need to have in mind just what exactly is required from the cell, in the purify-mode and in the regen-mode, but generally it will be found that the time periods of the regen-mode can be accommodated without need to increase the overall cycle time of the appliance. It is recognized that the cell can operate as it needs to do, within the cycles that are already present in the operations of the appliance.

Another time-related aspect is the residence-time that the regen water must spend in the cartridge, in order to become saturated with citric acid, which can be a few minutes. But if there is a difficulty in that area, citric-water can be pre-stored in a storage tank, as described in FIG. 7.

Alternatively, the softener can be provided on an add-on after-market basis. In this case, it can be difficult to integrate the timing of the softener functions into the appliance controller. However, this is just a matter of linking in to the control functions of the appliance; the time periods and cycles needed to perform the softening operations are just as parallel to the inherent cycles of the appliance, whether the softener is inside or outside the box.

The following terms have special meanings for the purposes of this specification, namely:
Regen-water is water that is available to be conveyed into and through the softener, during regeneration of the softener. Typically, the regen-water is plain hard mains-water upon admission into the softener, then is chelated, then accepts hardness ions, then is conveyed to drain and disposed of.
Chelate-water is regen-water that is saturated with dissolved chelate, or at least contains dissolved chelate at such concentration as to be effective substantially to inhibit precipitation of such hardness ions as may be present in solution in the chelate-water.
Citric-water is chelate-water in which the chelate is citric acid.

Typically, citric-water has a pH of 4 pH or below, as a result of being in contact with the citric acid pellets in the cartridge for a substantial residence time. Preferably, the pellets have diameters in the size range 3 mm to 20 mm.

Certain volumes of water have been given specific names, herein, as follows:
Vspaces=the aggregate water volume capacity of all the capacitance-spaces in the cell.
Vcell=the water volume capacity of the cell, between its inlet and outlet ports (Vcell includes Vspaces+the capacities of the plenums).
Vcartridge=the water volume capacity of the cartridge, when filled with solid soluble pellets of chelate.
Vregen=the volume of regen-water that moves into the cartridge during the displacement-phase of regenerate-mode.
Vchelate=the volume of chelate-water that was in the cartridge prior to the displacement-phase, and is moved into the cell during the displacement-phase. (Numerically, Vregen=Vchelate.)
Vcitric=Vchelate when the chelate is citric acid.
Vreservoir=the volume of softened mains-water that enters the reservoir during the purify-mode.

The numerals used in the drawings are summarized as:

20 washing appliance

23 box/housing of the appliance 20

25 water reservoir of the appliance

27 heater, in the reservoir

29 CDI-based water-softener

30 CDI cell

32 cartridge

33 citric acid pellets contained in the cartridge

34 controller of operations

36 mains-water inlet of the appliance

38 water outlet of the appliance

40 transfer valve, conducts water from reservoir.

41 spare cartridge

43 electrical power supply

45 electrodes of the CDI cell

47 spaces between the electrodes =capacitance spaces

49 regen-water inlet

50 conduit, connects cartridge to cell

52 entry-plenum of cell

54 exit-plenum of cell

56 storage-tank for regen-water

58 valve

60 piston

63 inlet-port of cell

65 outlet-port of cell

The scope of the patent protection sought herein is defined by the accompanying claims. The apparatuses and procedures shown in the accompanying drawings and described herein are examples.

1. A washing appliance, in combination with a water softener, wherein:
the appliance includes a water inlet-port, through which incoming water containing hardness ions is received into the appliance;
the appliance includes a water reservoir, to which water, having been softened, is delivered;
the appliance includes a used-water-drain, through which water, having been used for a washing operation, is conveyed away from the appliance;
the softener includes a chelate-cartridge containing a soluble chelate;
the softener includes a regen-water inlet-port, through which regen-water is received, and conveyed into the cartridge;
the softener includes a regen-water-drain, through which the regen-water is conducted away from the appliance;
the softener includes a hardness-ions-extraction-structure, and a hardness-ions-retention-structure;
the softener is switchable between a purify-mode and a regenerate-mode;
the softener includes a controller, for controlling the operations of the softener during the purify-mode and regenerate-mode;
the controller is effective to control passage of water through the softener;
the controller is arranged, in purify-mode:
(a) to pass the water to be softened through the hardness-ions-extraction-structure;
(b) to render the hardness-ions-extraction-structure effective to extract hardness ions out of the water;
(c) to render the hardness-ions-retention-structure effective to retain the extracted hardness ions;
(d) to pass the resulting softened water to the water reservoir of the appliance;
the controller is arranged, in regenerate-mode:
(a) to pass regen-water through the hardness-ions-retention-structure;
(b) to render the hardness-ions-retention-structure effective to release or repel the hardness-ions therefrom, into the regen-water;
(c) prior to the regen-water passing through the hardness-ions-retention-structure, to pass the regen-water through the chelate-cartridge;
(d) to render the chelate-cartridge effective to chelate the regen-water, the regen-water being chelated when the regen-water is substantially concentrated with dissolved chelant, and being then termed chelate-water;
(e) to cause the hardness ions released from the hardness-ions-retention-structure to enter the chelate-water;
(f) to dispose of the chelate-water, containing the hardness ions, through the regen-water-drain.

2. As in claim 1, wherein:
the appliance includes a housing or box;
the box houses the water-reservoir and other components of the washing appliance, and houses the water-softener;
the box is provided with connections between components of the appliance and outside services, including:
(a) the water-inlet port and the regen-water inlet-port;
(b) the used-water-drain and the regen-water-drain;
(c) an electrical connection to a supply of electricity.

3. As in claim 1, wherein the water-softener includes a capacitive deionization (CDI) cell, having the following structural features:
the CDI cell includes at least one pair of electrodes;
the CDI cell includes an electrical power unit;
the electrodes include respective thin sheets of conductive material;
the conductive material is a high-surface-area material;
the electrodes are so arranged that capacitive-portions thereof lie in such close-spaced face-to-face overlapping relationship as to create, when charged, a substantial capacity therebetween;
the capacitive-portions of the electrodes that lie in that relationship define a thickness and a perimeter of a capacitance-space located between the electrodes;
the capacitance-space is defined as to its thickness by the face-to-face separation distance between the electrodes;
the capacitance-space is defined as to its perimeter in that, outside the perimeter of the capacitance-space, the electrodes are either curtailed, or the face-to-face separation distance between the electrodes is too large for substantive capacitive deionization to take place;
the CDI cell includes conduits capable of conveying water into, through, and out of, the capacitance space;
the purify-mode is a purify-mode of the CDI cell, and the regenerate-mode is a regenerate-mode of the CDI cell;
the hardness-ions-extraction-structure and the hardness-ions-retention-structure are formed in and by the said at least one pair of electrodes of the CDI cell.

4. As in claim 3, wherein the controller is arranged, when switched to purify-mode:
to conduct the water to be softened into, through, and out of, the CDI cell and through the capacitance-space thereof;
to use the power unit to charge the electrodes of the pair at opposite polarity, to a voltage that is high enough to create substantial capacitive action in the space between the electrodes, and yet low enough to avoid triggering electrolytic redox reactions in water being softened in the capacitance-space between the electrodes;
wherein the controller is switchable between three phases of the regenerate-mode, being a displacement-phase, a release-phase, and a purge-phase;
wherein the controller is arranged, when switched to the displacement-phase:
(a) to displace water from the capacitance-space of the pair of electrodes, and to replace it with chelate-water from the chelate-cartridge;
(b) to switch from displacement-phase to release-phase upon the capacitance-space becoming filled with chelate-water;
wherein the controller is arranged, when switched to the release-phase:
(a) to so arrange the electrodes electrically that the pair of electrodes become electrically discharged;
(b) to so arrange the electrodes electrically that the hardness ions retained in the electrodes are electrically released or repelled therefrom, into the chelate-water;
(c) to switch from release-phase to purge-phase upon the cell becoming electrically discharged;
wherein the controller is arranged, when switched to the purge-phase:
(a) to purge water from the cell, removing the chelate-water containing the hardness-ions, and to dispose of same through the regen-water-drain;
(b) to cease the regenerate-mode when the cell has been thus purged.

5. As in claim 3, wherein:
a capacitance-volume of the said capacitance-space is the product of the area enclosed by its perimeter and its thickness;
insofar as the cell includes two or more pairs of electrodes, the pairs having respective capacitance-volumes, an aggregate-capacitance-volume, termed Vspaces, of the cell is the sum of the respective capacitance-volumes;
in the displacement-phase, the volume of chelate-water admitted into the CDI cell is termed Vchelate;
and Vchelate is larger than Vspaces.

6. As in claim 5, wherein:
the cell includes inlet and outlet plenums;
the water capacity volume of the cell, termed Vcell, includes Vspaces and includes the capacity volumes of the plenums;
and Vchelate is larger than Vcell.

7. As in claim 1, wherein the soluble chelate is a soluble acid, whereby the chelate-water is of low pH.

8. As in claim 7, wherein:
the soluble chelate is citric acid, and the chelate-water is termed citric-water;
the citric acid in the cartridge is in the form of solid pellets, which are between 3 mm and 20 mm in diameter;
the water volume capacity of the cartridge, when filled with the pellets, is Vcartridge;
volume operational conditions are such that a volume Vcartridge of the regen-water remains in the cartridge, in contact with the citric-acid pellets, for a residence time of at least two minutes;
and Vcartridge is greater than Vcell.

9. As in claim 5, wherein the controller is arranged, during the release-phase of the regenerate-mode, to keep the chelate-water stationary relative to the cell.

10. As in claim 1, wherein the softener includes a storage tank, having an inlet port for receiving chelate-water from the cartridge, and having an outlet port for transferring the chelate-water to the cell.

11. Procedure for softening hard water for use in a washing appliance, characterized by including:
where the appliance includes a water-inlet port;
where water received at the water-inlet port is hard water, in that the received-water contains substantial amounts of dissolved ions of calcium or magnesium, or both, termed hardness-ions;
switching a water softener of the appliance to purify-mode;
where, in its purify-mode, the softener is effective to remove hardness-ions from solution from the received-water, and to retain them within the softener;
operating the softener in its purify-mode for such period of time that the softener becomes laden with hardness-ions removed from the received-water; and
passing the received-water, from which hardness-ions have been removed, into a water-reservoir of the appliance;
switching the softener of the appliance to regenerate-mode;
where, in its regenerate-mode, the softener has the capability to release or repel retained ions into water present in the softener;
operating the softener in its regenerate-mode, including:
(a) first admitting a volume Vchelate of chelate-water into the softener;
where the chelate-water contains a substantial proportion of a chelate;
where the volume Vchelate and the said proportion are of such magnitude, and the chelate is of such character, that the volume of chelate-water is effective to take and retain hardness-ions that have been released or repelled from the softener, into solution;
(b) then operating the softener in such manner as to release or repel hardness-ions that have been removed from the received-water, from the softener and into the chelate-water; and
moving the chelate-water, together with the hardness-ions now retained in solution therein, out of the appliance.

12. As in claim 11, wherein the water-softener cell is or includes a capacitive deionization (CDI) cell, having the following structural features:
the CDI cell includes a pair of electrodes;
the CDI cell includes an electrical power supply, which is capable of charging the electrodes with opposite polarity;
the electrodes include respective thin sheets of conductive material;
the conductive material is a high-surface-area material;
the electrodes are so arranged that capacitive-portions thereof lie in such close-spaced face-to-face overlapping relationship as to create, when charged, a substantial capacity therebetween;
the capacitive-portions of the electrodes that lie in that relationship define a thickness and a perimeter of a capacitive-space located between the electrodes;
the capacitive-space is defined as to its thickness by the face-to-face separation distance between the electrodes;
the capacitive-space is defined as to its perimeter in that, outside the perimeter of the capacitive-space, the electrodes are either curtailed, or the face-to-face separation distance between the electrodes is too large for substantive capacitive deionization to take place;
the CDI cell includes conduits that are capable of conveying water into, through, and out of, the capacitance space;
the said purify-mode is a purify-mode of the CDI cell, and the said regenerate-mode is a regenerate-mode of the CDI cell;
the softener includes a CDI-controller that is effective to switch between the two phases.
